(19) United States
(12) Patent Application Publication
(10) Pub. No.: US 2009/0040366 A1
(43) Pub. Date: Feb. 12, 2009

(54) Transmitting Video Signals from a Camera of an Operating Lamp System

(75) Inventor: Thomas Voelker, Hanau (DE)

Correspondence Address: FISH & RICHARDSON PC, P.O. BOX 1022, MINNEAPOLIS, MN, 55440-1022, US

(73) Assignee: TRUMPF MEDIZIN SYSTEME GMBH + CO. KG, Puchheim (DE)

(21) Appl. No.: 12/187,607

(22) Filed: Aug. 7, 2008

(30) Foreign Application Priority Data
Aug. 8, 2007 (EP) 07 015 565.0

(51) Int. Cl. H04N 5/222

(52) U.S. Cl. 348/370; 348/E05.022

(57) ABSTRACT

An operation lamp system includes an adjustable mount, an operation lamp mounted to the adjustable mount, a camera mounted to the adjustable mount, a signal compression device mounted to the adjustable mount. The signal compression device is configured to provide a compressed video signal from a video signal of the camera. The operation lamp system further includes a camera control device, and a transmission system arranged along the adjustable mount and including a video connection electrically connecting the signal compression device and the camera control device.

### CROSS REFERENCE TO RELATED APPLICATION

This application claims priority under 35 U.S.C. §119(a) to European Patent application No. 07 015 565.0, filed on Aug. 08, 2007, the contents of which are hereby incorporated by reference in their entirety.

### TECHNICAL FIELD

The invention relates to transmitting a video signal of a camera within an operating lamp system. In particular, the invention relates to delivering the video signal of the camera through an OR lamp support system of the operating lamp system.

### BACKGROUND

Operation lamp systems are generally used to provide illumination of regions of interest during medical operations, e.g., surgeries. Operation lamps are usually mounted on adjustable mounts to allow repositioning as needed during the medical operations. A video camera can be used to image the illuminated region for, e.g., recording the surgery.

### SUMMARY

In a first aspect, the invention features operation lamp systems that include an adjustable mount, an operation lamp mounted to the adjustable mount, a camera mounted to the adjustable mount, a signal compression device mounted to the adjustable mount, the signal compression device configured to provide a compressed video signal from a video signal of the camera, a camera control device, and a transmission system arranged along the adjustable mount and including a video connection electrically connecting the signal compression device and the camera control device.

In another aspect, the invention features methods for transmitting multiple signal components of a video signal in an operation lamp system via a transmission system, wherein the number of channels of the transmission system available for transmitting the video signal is smaller than the number of signal components of the video signal. The methods include compressing at least one of the signal components, thereby generating at least one compressed signal component, providing the at least one compressed signal component to the transmission system, transmitting the at least one compressed signal component via a channel of the transmission system, and uncompressing the video signal.

In another aspect, the invention features methods for operating an operation lamp system including an operation lamp, a camera, and a transmission system with a number of lamp channels for operating the operation lamp and a number of camera channels for transmitting a multi-component video signal of the camera, wherein the number of camera channels is smaller than the number of components of the multi-component video signal. The methods include controlling the operation lamp via the lamp channels, generating a compressed signal based on at least two components of the multi-component video signal, transmitting the compressed signal via a camera channel of the transmission system, and recovering the two components of the multi-component video signal from the transmitted compressed signal.

In another aspect, a video signal, especially a HDTV signal, with multiple signal components is transmitted via a transmission system, wherein a number of channels of the transmission system is smaller than the number of components of the video signal. The methods for transmitting the video signal include compressing at least one signal component, transmitting the at least one compressed signal component via a channel of the transmission system, and recovering the video signal.

In another aspect, the invention also relates to operating (OR) lamp systems including an operating lamp, an OR lamp support system, a camera delivering a video signal and arranged on the OR lamp support system, a camera control device, and a transmission system arranged within the support system and connected to the camera and the camera control device. In the OR lamp systems, the camera is provided with a device for compressing at least one signal component of the video signal.

By transmitting multiple compressed signals over the same channel, video transmission with a limited number of channels is possible.

Thus, one can transmit, e.g., HDTV signals via a transmission system with fewer (camera) channels than signal components. Then, one can use a conventional transmission system already in use for OR lamps, for example, when providing a retrofit camera to the OR lamp system.

Implementations can include one or more of the following features.

In some embodiments, the transmission system can include lamp connections for supplying the operation lamp with power and one or more control signals. The number of connections of the transmission system can be less than the sum of the number of the lamp connections and the number of connections required for the uncompressed video signal.

In various embodiments, the signal compression device can be configured to combine two or more components of the video signal into a single compressed signal and to provide the single compressed signal to the video connection.

In some embodiments, the mount can comprise at least two support arm segments connected rotatably to each other without rotation limit. For example, at least two support arm segments can be connected rotatably through a sliding contact.

In certain embodiments, the three signal components of an analog HDTV signal can be compressed for transmission over one or two video connections. For example, a compressed video signal can be generated from two color characterizing signal components. The operation lamp can further include an analog digital converter between the camera and the transmission system to provide a digital video signal to the transmission system. For example, the signal compression device can include an MPEG signal compression device.

In some embodiments, the compressed signal components can be provided to the transmission system at a speed that depends on the number of signal components transmitted via the same channel.

In certain embodiments, the method can further include digitizing the video signal or its signal components, thereby generating a digital signal. The compressing can include compressing the digital signal, thereby generating a compressed digital signal, which is then transmitted via one of the video channels.

In some embodiments, at least two analog signal components are compressed and transmitted via the same channel. By the distribution of the color signals, different values for the bandwidth result for the different signals. Because two color components (color characterizing components of the video signal) are obtained from adjacent pixels, color components have a significantly lower bandwidth. Thus, a compression and subsequent expansion in time can be performed during the transmission without having a consequence for the original signals, if the total path is operated with a high bandwidth. Moreover, one can compress more than two signal components, e.g. 3 signal components, and transmit them via the same channel.

Other advantages includes that the compressed signal components can be transmitted in a time-division multiplex. For example, 2 or 3 compressed signal components can be transmitted in this way.

In some embodiments, the compressed signal components are output to the transmission system at a speed that does depend on the number of signal components transmitted via the same channel. For example, the U and V signal components can be output in their respective timeline at double speed, respectively. Thus, during the time period for transmitting one row, the first component can be output in the first half of the time and the second component can be output in the second half of the time period, each with the double speed, respectively. On the other end of the transmission path (transmission system), a regeneration of the original signals can be performed. For example, the two portions of the color component parts serially contained in a transmitted “row” signal can be reconstructed to correspond to the original two signals, each with half the speed. Correspondingly, if three signal components have to be transmitted during the time period for one row, they have to be output with a higher speed, e.g., each signal with three times the speed or one signal with twice the speed and two signals with four times the speed.

In HDTV systems, one signal component can be transmitted uncompressed via a single channel. The highest bandwidth is usually required for the Y information. The Y information is required for the impression of sharpness and therefore should not be affected. Due to the compression of the other two (color) signal components, the Y signal component can be transmitted alone over its own channel. One can distribute the YUV components signal onto only two channels such that on one channel, the Y signal is transmitted differentially as an analog signal and on the second channel, a multiplexed UV signal (compressed U and V signal components) is transmitted. At the end of the signal processing, a three-channel YUV signal can be reconstructed that conforms to the standard, which may be the base for diverse conversions.

In other embodiments, a compressed video signal may be generated from two signal components.

In some embodiments, the video signal or its signal components can be digitized. Thus, a digital compressed signal can be generated and transmitted via a single channel. The HDTV signal can be represented in different formats, such as analog three-channel component representations and different kinds of digital formats in parallel or serial form. If the HDTV signal is present in a digital form or is brought into a digital form, an MPEG compression can be performed and the compressed signal can be transmitted via only one channel.

For an OR lamp system, a twisted line pair can be provided in the transmission system and form a channel via which a signal can be differentially transmitted. Preferably, a seven-pole system can be arranged within or on the support arms, wherein two lines (poles) can serve as power supplies and one line can be a protective ground conductor. The remaining four lines can be twisted as pairs. Each pair can be used as a channel for, e.g., the compressed color components (one channel) and a Y channel.

In certain embodiments, the support system can comprise at least two support arm portions connected to each other rotatably without limit. This means that a rotation by 360° or more can be possible, because no limit is provided. For this purpose, a contact ring system can be provided at the joint of the support arm portions allowing data transmission and power supply also via this joint. As extending the joint for more than two data channels can be difficult, transmission without compression of an HDTV signal may not be feasible.

The camera can output an analog HDTV signal having three signal components that can be compressed and transmitted.

In some embodiments, a time-division multiplexing device can be provided on the camera side. Thereby, one can output the compressed signal components delayed to each other to the transmission system and to transmit multiple signal components (in a compressed form) via the same channel.

To recover the original components, one can provide a time-division de-multiplexing device on the control device side.

In some embodiments, an A/D converter and an MPEG signal compression device can be provided on the camera side. Alternatively, possibly existing digital signals of the camera can be used directly. Thus, one can transmit compressed digital signals.

In certain embodiments, the camera mounted to the adjustable mount by being mounted to the operation lamp that is attached to the adjustable mount. The camera can be configured as a structural unit that includes further the signal compression device, and/or the time-division multiplexing device.

In some embodiments, the camera and the signal compression device are mounted to a first end of the adjustable mount while the camera control device is positioned at a second end of the adjustable mount. Thus, the camera and the camera control device are separated in space, and a transmission system along the adjustable mount provides the video connection. The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1a is a first schematic diagram of an OR lamp system.

FIG. 1b is a second schematic diagram of an OR lamp system.

FIG. 2 is a side view of an OR lamp system having a camera surrounded by lamps.

FIG. 3 is a perspective view of an OR lamp system having a camera arranged beside the operating lamp.

FIG. 4 is a flow chart illustrating the transmission of a video signal through a transmission system.

FIG. 5 is a sequence of diagrams illustrating the transmission of three signals by two lines (channels).

FIG. 6 is a sequence of diagrams illustrating the transmission of three signals by a single line (channel).

Like reference symbols in the various drawings indicate like elements.

### DETAILED DESCRIPTION

HDTV cameras generate a so-called YUV signal. The YUV signal distributes the information contained in an image onto three components (channels) Y. U, and V. The Y component delivers the brightness information. Taken alone, the Y component contains the grayscale information of the camera signal. The U and V components, also called vectors, map the position of the color point in the color wheel by their positive or negative voltage values, respectively.

The signal transmission of the YUV signal of an HDTV camera over an OR lamp support system can be problematic when sliding contacts are used in, e.g., joints without rotating angle limitation because the number of channels (lines) required for an analog transmission can be too high for a sliding contact. In joints without rotating angle limitation, the transmission system can comprise two line pairs twisted as pairs that are connected from arm to arm at the joints by contact rings so that the joints are freely rotatable without limit.

Even if the individual arm segments of the support system are formed in the shape of a tube, through which the lines are led, the arms are to be considered as “open” under radio frequency (RF) aspects, especially at the joints. Thus, there is no effective shielding of RF signals, which can affect transmitting digital signals.

A parallel transmission of the three components Y, U, and V of the video signal in addition to all the connections required for operating the OT lamp may not be possible because of insufficient availability of lines.

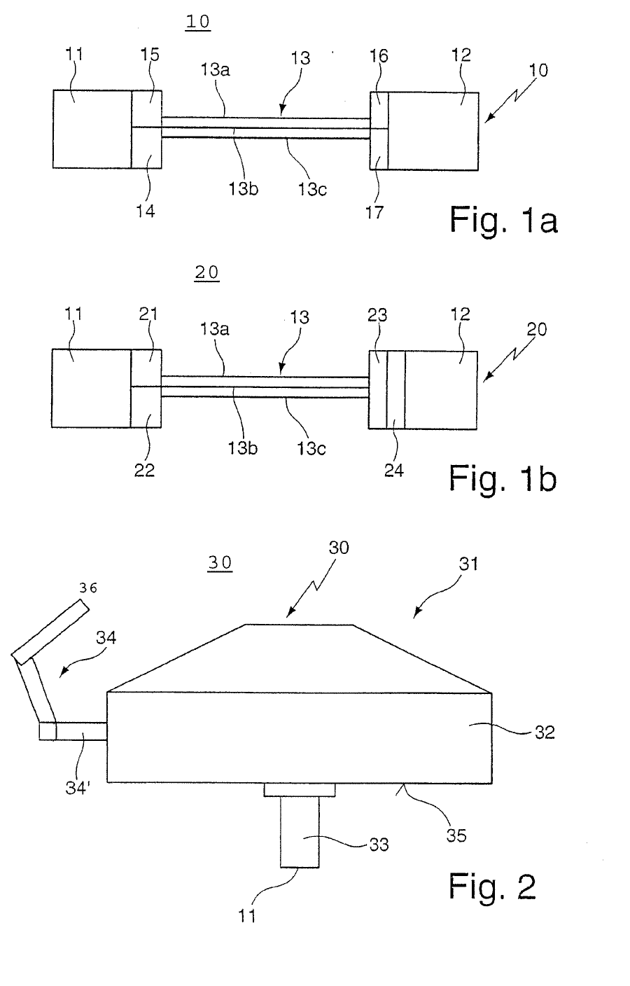

In FIG. 1a, an operating (OR) lamp system 10 includes a camera 11 arranged in an area of an operating lamp and a camera control device 12. A transmission system 13 of the OR lamp system 10 is provided between the camera 11 and the camera control device 12 and has less video channels 13a, 13b than the number of signal components of the video signal delivered by the camera 11. The transmission channels 13a, 13b each are formed as a twisted pair, respectively. For simplification shown as a single line 13c in FIG. 1a, lines for a power supply of the camera 11, operating the operation lamp, which is not shown in FIG. 1a, and a protective earth conductor are arranged parallel to the transmission channels 13a, 13b.

To enable a transmission of the video signal by the transmission system 13, a unit 14 for compressing at least one signal component is provided on the camera side of the transmission system 13. In addition, a time division multiplexing unit 15 allows sending compressed signal components delayed in time through the transmission system 13.

On the control device side of the transmission system, a time division de-multiplexing unit 16 and a unit 17 for decompressing are provided to recover the original signal components. One of the signal components can also be transmitted by the transmission system 13 in an uncompressed state. When transmitting the uncompressed component and the compressed components of the signal, one needs to be able to assign those signals to each other so that the original video signal can be recovered on the control device side of the transmission system 13. The control device 12, the time division de-multiplexing unit 16, and the unit 17 may be connected to a display such as a monitor, or they may be integrated therein.

In an alternative embodiment of an OR lamp system 20 as shown in FIG. 1b, an A/D converter 21 is provided on the camera side of the transmission system 13. The A/D converter 21 generates a digital signal from the analog video signal. With a compressing unit 22 formed as a MPEG compressing unit, the digital video signal can be compressed and then output to the transmission system 13. On the control device side of the transmission system 13, a corresponding MPEG decompressing unit 23 is provided to be able to recover the original digital video signal. Depending on which signal form is required for further processing, a D/A converter may additionally be provided to generate an analog signal, if the digital signal cannot be processed.

In FIG. 2, the side view of an operating lamp 31 of an OR lamp system 30 illustrates the principal construction. The operating lamp 31 has a lamp body 32 that has lamps in its interior (not shown in FIG. 2). By a support system 34, the lamp body 32 is swivel-mounted to a stationary mount 36 at a ceiling or wall of a building or of a mobile unit. The support system 34 includes a support arm configured as a swivel arm. The swivel arm is formed by several swivel arm segments 34′ connected to each other by joints. One of the swivel arm segments 34′ of the support system 34 is fixed to the operating lamp 31. Thus, the operating lamp can be moved and swiveled three-dimensionally in the X, Y, and Z directions. A handle 33 mounted at the lamp body 32 allows the positioning of the operating lamp 31 at an arbitrary position above an operating table.

The transmission system 13 is integrated into the support arm of the support system 34 and uses contact rings in the joint connections. Thus, the support arm segments 34′ can be freely rotated without a stop delimiting a relative movement of two adjacent support arm segments 34′.

At a lower side 35, light is emitted to illuminate an illuminated area, e.g., an operating area. The camera 11 is integrated into the handle 33 so that it is always directed towards the illuminated area. Thus, the camera 11 is mounted to the support system 34 via the handle 33 and the operating lamp 31.

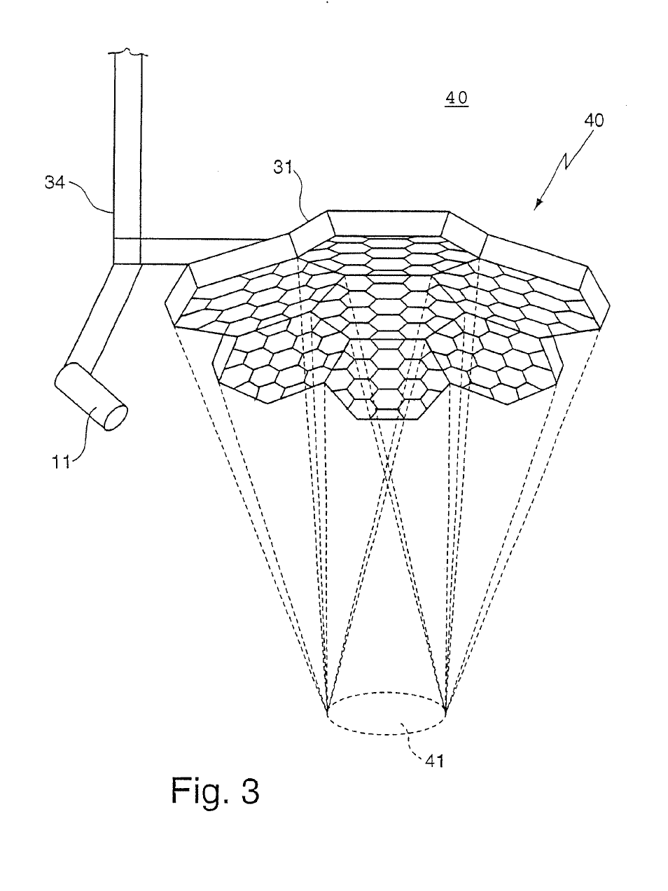

FIG. 3 shows an OR lamp system 40 in which the camera 11 is attached at the support system 34 next to the operating lamp 31. The camera 11 can be directed to an area 41 illuminated by the operating lamp 31 independently from the orientation of the operating lamp 31.

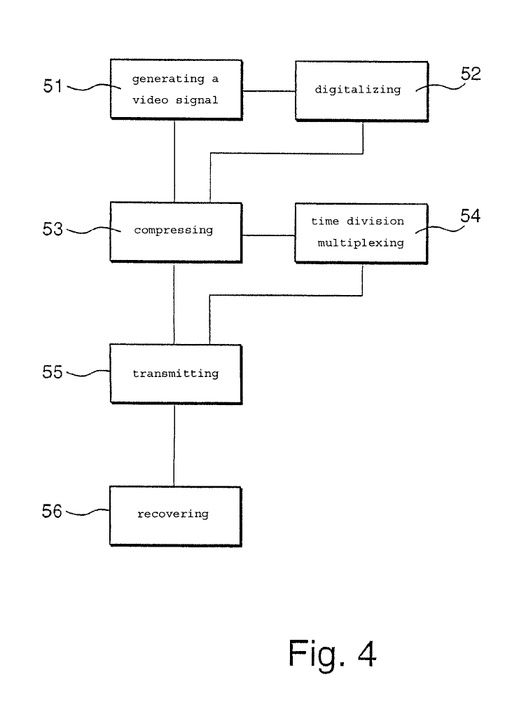

In the flow chart of FIG. 4, a video signal, e.g., an analog HDTV signal, is generated by the camera 11 (step 51). The video signal may be converted into a digital video signal (step 52) and then at least partial compressed (step 53). As an alternative, if the analog video signal or components of the analog video signal are to be compressed, they can be directly compressed (step 53). If one or multiple components of the analog signal were compressed, those compressed components can be subjected to a time division multiplex process (step 54), before they are forwarded to and transmitted by the transmission system 13 (step 55). A compressed digital signal can directly be forwarded to the transmission system for transmission (step 55). After transmission, the original video signal is recovered from the compressed signals or components (step 56).

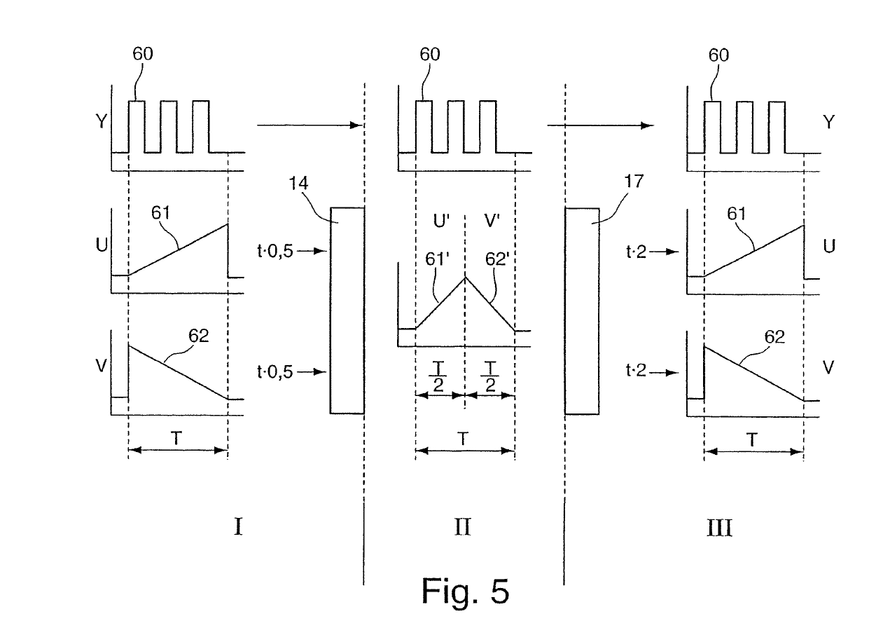

In FIG. 5, the transmitting process of a YUV video signal is illustrated in a sequence of diagrams according to three phases I, II, and III. Phase I corresponds to the signal generation side, e.g. the camera side. Phase II corresponds to the transmission path using two channels. Phase III corresponds to the signal receiving side, e.g., the control device side. The YUV signal has three signal components Y. U, and V, which during the time period T for one row of an image have waveforms 60-62, as shown in each of the Y, U, and V diagrams in phase I. The signal component Y having the waveform 60 is transmitted without modification over the first channel (using one line), so that the signal component Y with the waveform 60 is also present in area III.

The components U and V are supplied to the signal compression device 14, and the time is reduced by a factor of 0.5, for example. A compressed component U′ has accordingly the waveform 61′, for example, and a compressed component V′ has the waveform 62′, for example. The compressed components U′ and V′ each are transmitted one after another during a half time period T/2. Accordingly, the component V′ is delayed for a row with respect to components U′. The transmission of the components U′ and V′ is performed over the same channel (using the same line). In the decompression device 17, the original signal components U, V are recovered, for example by multiplying the time of the signals 61′, 62′ by a factor of 2, thereby generating the original waveforms 60-62.

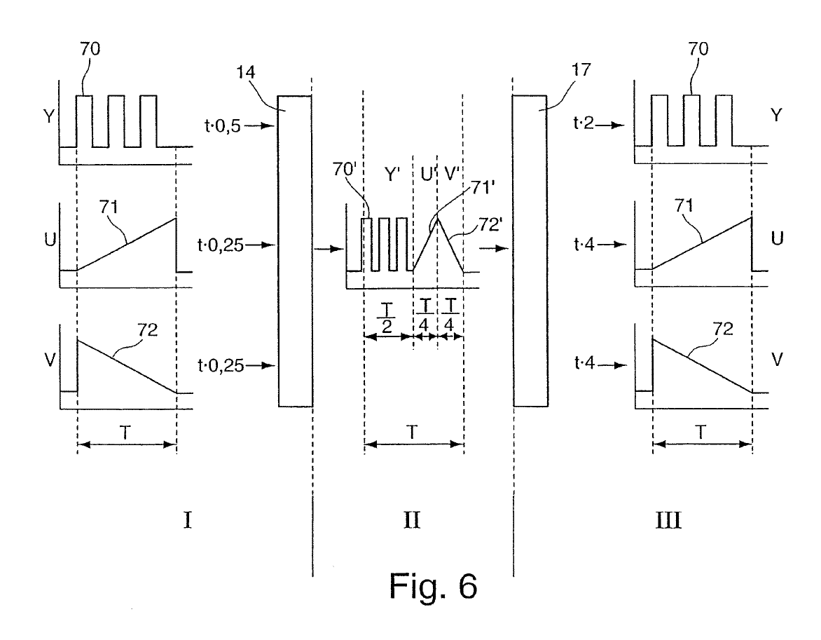

In FIG. 6, the use of a single line for the three components Y, U, and V is illustrated. The signal transmission is again split into the three phases I, II, and III, wherein phase I corresponds to the signal generation side, e.g. the camera side, phase II corresponds to the transmission path with a single line (channel), and phase III corresponds to the signal receiving side, e.g. the control device side. The signal to be transmitted has three components Y, U, V, which during the time period T for one row have the waveforms 70, 71, and 72, respectively.

The components Y, U, and V, are supplied to the signal compression device 14, wherein, for example, the time of the component Y is multiplied by a factor of 0.5 and the time of the signal components U and V is multiplied by a factor of 0.25. The compressed components Y′, U′, and V′ have waveforms 70′, 71′, and 72′, respectively. The compressed component Y′ is transmitted during a half time period T/2 for a row and the compressed components U′ and V′ each are transmitted during a quarter time period T/4. For a single row of an image, the compressed components Y′, U′, and V′ are transmitted with a delay, i.e., the compressed components Y′, U′, and V′ are transmitted one after the other. The transmission can therefore be performed over the same channel (the same line). In the decompression device 17, the original components Y, U, and V are recovered, for example by multiplying the time of the waveform 70′ by a factor of 2 and the time of the waveforms 71′, 72′ by a factor of 4, thereby generating the original waveforms 70-72.

A number of embodiments of the invention have been described. Nevertheless, it will be understood that various modifications may be made without departing from the spirit and scope of the invention. Accordingly, other embodiments are within the scope of the following claims.

What is claimed is:

1. An operation lamp system comprising:
an adjustable mount;
an operation lamp mounted to the adjustable mount;
a camera mounted to the adjustable mount;
a signal compression device mounted to the adjustable mount, the signal compression device configured to provide a compressed video signal from a video signal of the camera;
a camera control device; and
a transmission system arranged along the adjustable mount and including a video connection electrically connecting the signal compression device and the camera control device.

2. The operation lamp system of claim 1, wherein the transmission system further includes lamp connections for supplying the operation lamp with power and one or more control signals.

3. The operation lamp system of claim 2, wherein the number of connections of the transmission system is less than the sum of the number of the lamp connections and the number of connections required for an uncompressed video signal.

4. The operation lamp system of claim 1, wherein the signal compression device is configured to combine two or more components of the video signal into a single compressed signal and to provide the single compressed signal to the video connection.

5. The operation lamp system of claim 1, wherein the mount comprises at least two support arm segments connected rotatably to each other without rotation limit.

6. The operation lamp system of claim 5, wherein the at least two support arm segments connected rotatably through a sliding contact.

7. The operation lamp system of claim 1, wherein the camera is configured to output an analog HDTV signal having three signal components.

8. The operation lamp system of claim 7, wherein the three signal components are compressed for transmission over one or two video connections.

9. The operation lamp system of claim 1, further comprising a time-division multiplexing device between the camera and the transmission system.

10. The operation lamp system of claim 1, further comprising a time-division de-multiplexing device between the transmission system and the control device.

11. The operation lamp system of claim 1, further comprising an analog to digital converter between the camera and the transmission system for providing a digital video signal to the transmission system.

12. The operation lamp system of claim 1, wherein the signal compression device includes an MPEG compression device.

13. The operation lamp system of claim 1, wherein the camera is mounted to the adjustable mount by the camera being attached to the operation lamp mounted to the adjustable mount.

14. A method for transmitting multiple signal components of a video signal in an operation lamp system via a transmission system, wherein the number of channels of the transmission system available for transmitting the video signal is smaller than the number of signal components of the video signal, the method comprising:
compressing at least one of the signal components, thereby generating at least one compressed signal component;
providing the at least one compressed signal component to the transmission system;
transmitting the at least one compressed signal component via one of the channels of the transmission system; and
uncompressing the video signal.

15. The method of claim 14, wherein at least two signal components are compressed and transmitted via the same channel.

16. The method of claim 14, wherein at least two signal components are compressed and transmitted in a time-division multiplex.

17. The method of claim 14, wherein the compressed signal components are provided to the transmission system in a speed that depends on the number of signal components transmitted via the same channel.

18. The method of claim 14, wherein a signal component is transmitted uncompressed via a channel.

19. The method of claim 14, wherein a compressed video signal is generated from two color characterizing signal components.

20. The method of claim 14, further comprising
digitizing the video signal or its signal components in a digital signal; and wherein compressing includes compressing the digital signal, thereby generating a compressed digital signal, which is then transmitted via the channel.

21. A method for operating an operation lamp system including an operation lamp, a camera, and a transmission system with a number of lamp channels for operating the operation lamp and a number of camera channels for transmitting a multi-component video signal of the camera, wherein the number of camera channels is smaller than the number of components of the multi-component video signal, the method comprising:
controlling the operation lamp via the lamp channels;
generating a compressed signal based on at least two components of the multi-component video signal;
transmitting the compressed signal via a camera channel of the transmission system; and
recovering the two components of the multi-component video signal from the transmitted compressed signal.

22. The method of claim 21, wherein generating a compressed signal includes compressing at least one component of the multi-component video signal.

23. The method of claim 21, wherein generating a compressed signal includes time-division multiplexing at least one component of the multi-component video signal.
